(19) United States
(12) Patent Application Publication
(10) Pub. No.: US 2026/0160129 A1
(43) Pub. Date: Jun. 11, 2026

(54) Mounting bracket for mounting a motorized screen onto a construction and method for manufacturing the mounting bracket

(71) Applicant: Coulisse B.V., Enter (NL)

(72) Inventors: Bastiaan Franciscus Klein Tuente, Groenlo (NL); Jochem Andreas Nijland, Hengelo (NL); Ike Essink, Wierden (NL); Niels Schrooten, Enter (NL)

(73) Assignee: Coulisse B.V., Enter (NL)

(21) Appl. No.: 19/405,482

(22) Filed: Dec. 2, 2025

(30) Foreign Application Priority Data
Dec. 11, 2024 (NL) 2039300

(51) Int. Cl. E06B 9/42; E06B 9/72

(52) U.S. Cl. CPC E06B 9/42; E06B 9/72

(57) ABSTRACT

The present invention refers to a mounting bracket (20) for mounting a motorised screen that is provided with a rotatable tube and a motor (12) for rotating the tube to a construction. The mounting bracket comprises a mounting plate (21) of stiff material provided with locking means, which are arranged for locking the motorised screen, and a mounting support (22) for mounting to the construction, which is connected to the mounting plate. The mounting bracket comprises a locking plate (23) of stiff material, wherein the locking means (231) are accommodated, and a damping zone (27) of vibration damping material that connects the locking plate to the mounting plate.

The invention also refers to a method for manufacturing the mounting bracket according to the invention.

The invention further refers to an assembly of a mounting bracket (20) according to the invention and a bracket holder (30), which is provided with fastening means (31, 32, 33) for forming a click lock with the locking means of the mounting bracket.

The present invention refers to a mounting bracket for mounting a motorised screen, such as window covering, to a construction, such as a surface or an elongated profile, wherein the motorised screen comprises a rotatable tube and a motor, which is arranged for rotating the tube, which mounting bracket comprises a mounting plate of stiff material and is provided with locking means, which are arranged for locking the motorised screen, wherein the mounting bracket further comprises a mounting support for mounting to the construction, which mounting support is connected to the mounting plate.

Such a mounting bracket is known from the European patent EP2933428 of the same applicant. The known mounting bracket cooperates with a holder on a rotatable shaft of the screen that is arranged for accommodating plate-shaped locking means. After mounting the known mounting brackets onto the construction, a window covering provided with suitable holders can be clicked slidably in the mounting brackets in a plane substantially perpendicular to the shaft. The mounting plate with plate-shaped locking means results in a minimal light gap when mounted on the inside of the walls or window frames.

The known mounting bracket has the disadvantage of, in a motorised screen, transmitting the vibrations of the motor to the construction, which in some situations can cause annoying noise when operating the screen.

The present invention aims to provide an improved mounting bracket according to the preamble of claim 1 that dampens or absorbs vibrations of the motor when in use.

The mounting bracket according to the present invention is thereto characterised, in that the mounting bracket comprises a locking plate of stiff material, wherein the locking means are accommodated, and that the mounting bracket comprises a damping zone of vibration damping material that forms a connecting layer between the locking plate and the mounting plate and runs along a part of the contour of the locking plate, wherein the mounting plate, the damping zone and the locking plate substantially extend in the same plane.

The mounting bracket according to the present invention has the advantage that the damping zone of vibration damping material forms the only connection between the locking plate and the mounting plate and therefore acoustically isolates the locking means with respect to the mounting support. Furthermore the thickness of the mounting bracket according to the present invention is determined by the thickness of the damping zone and can be kept minimal. This results in a minimal light gap of the motorised screen.

US20060086874A1 discloses a mounting bracket for a tubular motor system that is arranged for absorbing vibrations of the motor when in use. The known mounting bracket consists of three separate components: a stiff component for mounting to the construction, a stiff component for fastening to the tubular motor system, and a flexible element of vibration-absorbing material that connects the two stiff components with each other. The flexible element is arranged for allowing more displacement of the tubular motor system in the horizontal direction than in the vertical direction. In all embodiments, the flexible element consists of multiple suspension cords.

The mounting bracket from US20060086874A1 has the disadvantage that space is required for the intended horizontal displacement, as a result of which in many situations a light gap will appear when mounting the tubular motor system on the inside of the walls or window frames.

On the other hand, the mounting bracket according to the invention holds any motorised screen in mounted state in use in position with little to no light gaps. Furthermore, the mounting bracket according to the present invention allows for easier mounting by means of a single displacement in a plane substantially perpendicular to the tube.

In an elegant, preferred embodiment, the mounting plate, the damping zone and the locking plate are permanently connected. Because of that, the mounting bracket can be used without any additional actions and/or tools.

In an optimal preferred embodiment, the mounting plate has a preferably central recess, wherein the locking plate is at least partly accommodated, and the damping zone runs along the contour of the recess. Herein, the damping zone runs in the plane of rotation of the tube and prevents unwanted torsion when operating the motor.

In a further elaboration of the optimal preferred embodiment, the recess is larger than the locking plate and the damping zone bridges the space between the locking plate and the recess. The larger damping zone provides stiffness to the mounting bracket and has a greater reducing effect on the torsion.

In a practical preferred embodiment, the damping zone is part of a collar that extends partly over the mounting plate and partly over the locking plate.

In a first preferred embodiment, the damping zone has a closed structure. The closed structure leads to a strong, form-fitting connection between the mounting plate and the locking plate. Furthermore, a damping zone with a closed structure is easy to manufacture.

In a second, alternative preferred embodiment, the damping zone at least partly has an openwork structure.

Preferably, the vibration damping material comprises rubber, preferably synthetic rubber, such as silicone rubber.

More preferably, the damping zone is manufactured from liquid silicone rubber (LSR). By using liquid silicone rubber, the mounting bracket according to the invention can be manufactured by means of injection moulding techniques.

According to a complete preferred embodiment, the damping zone is arranged for cooperation with a cap that largely hides the mounting bracket from view.

According to a reliable preferred embodiment, the locking means comprise at least one locking tooth that is arranged for click locking in fastening means on the motorised screen.

In a further elaboration of the reliable preferred embodiment, the locking means comprise two guiding teeth, which are attached to either side of the locking tooth, wherein the guiding teeth are arranged for guiding the fastening means on the motorised screen. Together with the locking tooth, the guiding teeth form a fork and function as positioners, thus facilitating fast and accurate mounting.

In another preferred embodiment, the locking means are formed by one or more openings or recesses on the locking plate, which are arranged for accommodation of fastening means on the motorised screen.

The present invention also relates to a method for manufacturing a mounting bracket for mounting a motorised screen to a construction, which mounting bracket comprises a mounting support for mounting to the construction and a mounting plate of stiff material arranged for locking the motorised screen, whereby the method comprises the following steps:
a) Positioning the mounting plate in a mould;
b) Positioning a locking plate with locking means of stiff material in the mould at some distance from the mounting plate;
c) Applying liquid vibration damping material in the mould in the space between the mounting plate and the locking plate such that the liquid vibration damping material forms the contact between the mounting plate and the locking plate; and
d) Letting the liquid vibration damping material cure.

The present invention also relates to an assembly of a mounting bracket according to the invention and a bracket holder, wherein the bracket holder is provided with fastening means that are arranged for forming a click lock with the locking means of the mounting bracket.

The invention will now be described in more detail with reference to the figures, wherein

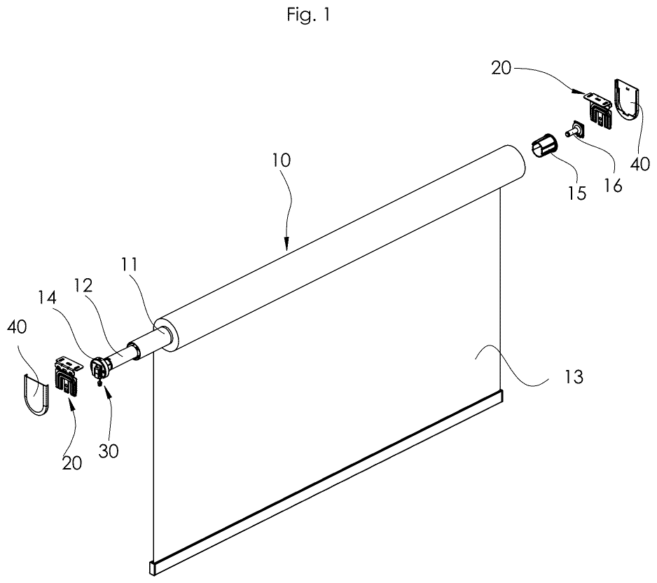

FIG. 1 shows a schematic view of a motorised roller blind with a first preferred embodiment of a mounting bracket according to the invention in disassembled parts;

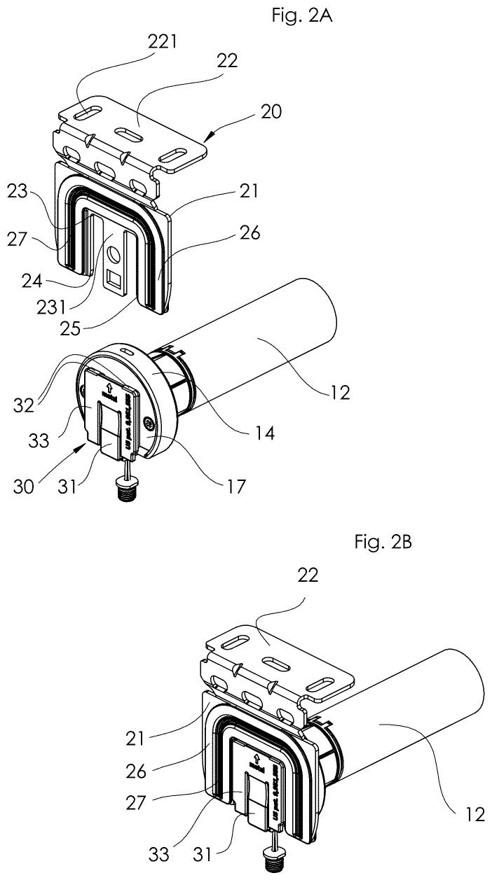

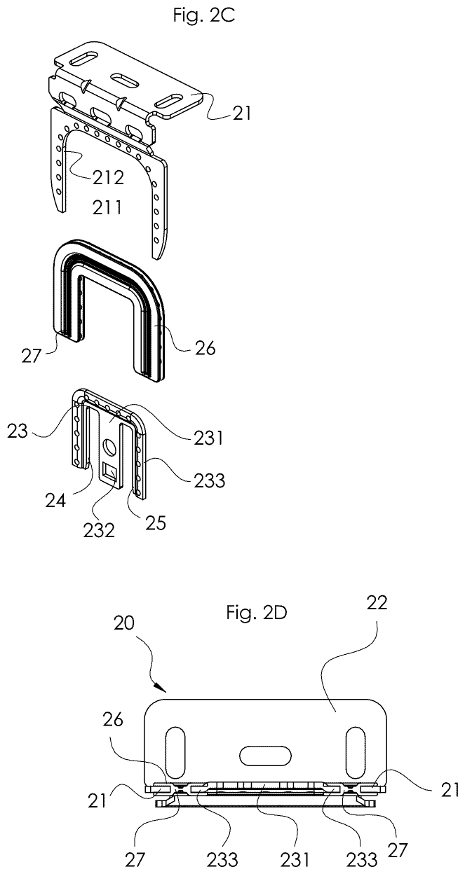

FIG. 2A shows a schematic view of the mounting bracket from FIG. 1 in more detail in a first position;

FIG. 2B shows a schematic view of the mounting bracket from FIG. 2A in a second position;

FIG. 2C shows an exploded view of the mounting bracket from FIG. 2A;

FIG. 2D shows a bottom view of the mounting bracket from FIG. 2A;

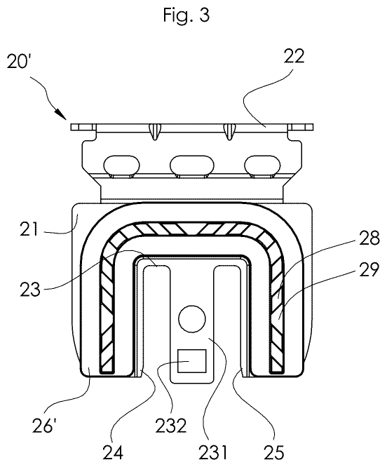

FIG. 3 shows a front view of a variant of the first preferred embodiment of the mounting bracket according to the invention;

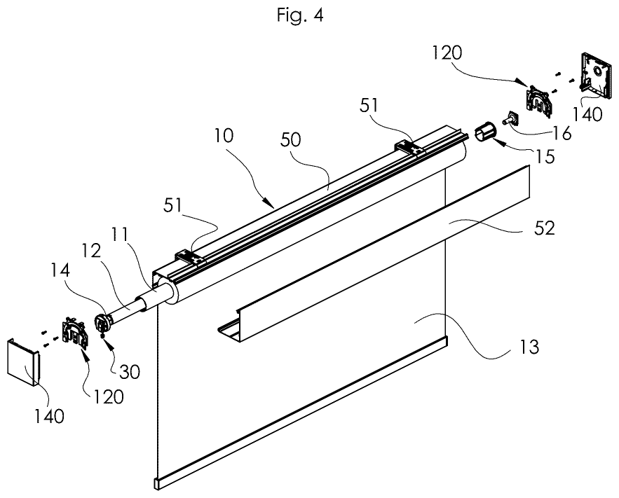

FIG. 4 shows a schematic view of a motorised roller blind with a second preferred embodiment of a mounting bracket according to the invention in disassembled parts;

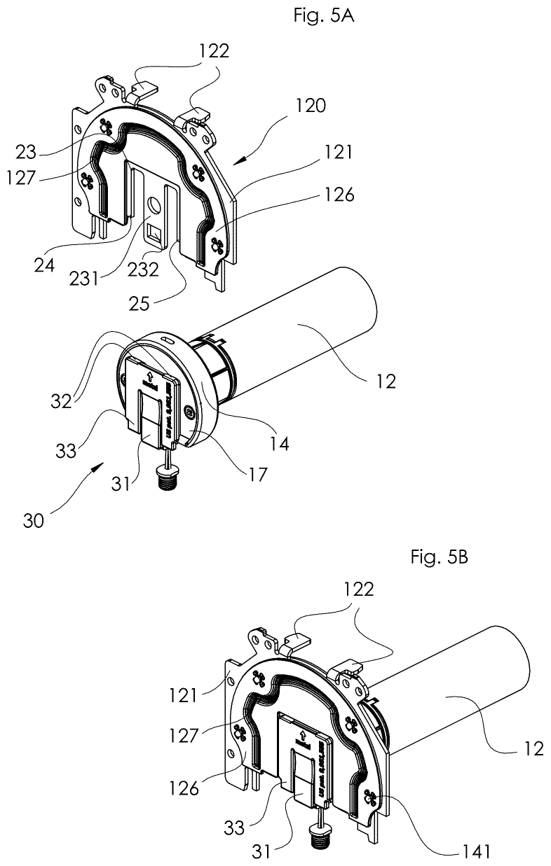

FIG. 5A shows a schematic view of the mounting bracket from FIG. 4 in more detail in a first position;

FIG. 5B shows a schematic view of the mounting bracket from FIG. 5A in a second position;

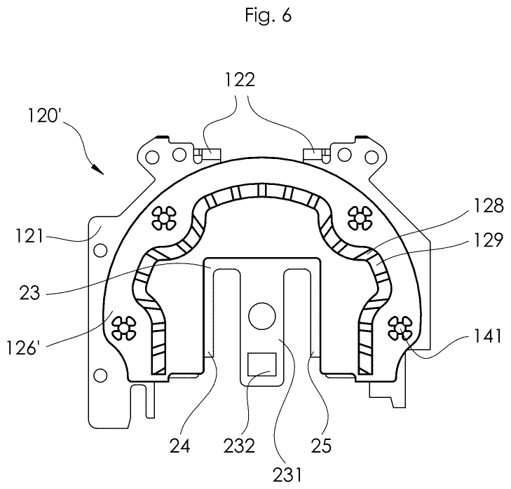

FIG. 6 shows a front view of a variant of the second preferred embodiment of the mounting bracket according to the invention.

Similar reference numbers in the different figures indicate similar parts.

FIG. 1 shows a schematic view of a motorised screen 10 with a first preferred embodiment of a mounting bracket 20 according to the invention in disassembled parts. FIG. 2A shows the mounting bracket 20 and the bracket holder 30 from FIG. 1 in a first position, in which they are placed separate from each other. FIG. 2B shows the mounting bracket 20 and the bracket holder 30 from FIG. 2A in a second, assembled position.

The motorised screen is a roller blind 10 with a rotatable tube 11 and a tubular motor 12, which is accommodated in the rotatable tube and is arranged for allowing the tube 11 to rotate. The tube 11 and the tubular motor 12 together form the tubular motor system. Onto the tube, a flexible screen material in the shape of a fabric 13 is fixed that rolls up or unrolls when operating the motor 12.

On one outer end (motor side) of the tube 11, the tubular motor 12 is located with a motor head 14 and a bearing that is cooperating with the tube 11 in the conventional way. On the opposite outer end (non-motor side) of the tube 11, an end plug 15 and a bearing pin 16 that is arranged for accommodation in the end plug 15 are located.

Both the motor head 14 and the bearing pin 16 have an outward-facing surface on to which a bracket holder 30 is attached, which is arranged for cooperation with the mounting bracket 20. In FIG. 2A the surface 17 of the motor head 14 is visible. The bracket holder 30 is arranged for detachable mounting on the mounting bracket 20. The cooperation between the bracket holder 30 and the mounting bracket 20 will be explained further on.

In the first preferred embodiment, the mounting bracket 20 is arranged for mounting on a ceiling or a top side of a window frame. The mounting bracket 20 is thereto provided with a mounting support 22 of stiff material. In the first preferred embodiment, the mounting support 22 is provided with holes for screws or bolts, for example.

The mounting bracket 20 is provided with a mounting plate 21. The mounting plate 21 is manufactured from stiff material and is connected with the mounting support 22.

The mounting bracket 20 is further provided with a locking plate 23. The locking plate 23 is manufactured from stiff material and provided with locking means 231 that are arranged for locking in the bracket holder 30.

According to the invention, the mounting bracket 20 further comprises a damping zone 27 of vibration damping material, which damping zone 27 connects the locking plate 23 with the mounting plate 21.

FIG. 2C shows an exploded view of the mounting bracket from FIG. 2A. In the shown preferred embodiment, the mounting plate 21 has a substantially central recess 211, wherein the locking plate 23 is accommodated. The recess 211 is larger than the locking plate 23. The damping zone 27 bridges the distance between the outer contour 233 of the locking plate 23 and the inner contour 212 of the recess 211.

FIG. 2D shows a bottom view on the mounting bracket 20 from FIG. 2A.

The damping zone 27 is part of a collar 26, that extends partly over the mounting plate 21 and partly over the locking plate 23. The collar 26 has a general H-shaped cross-section with the damping zone 27 in the middle. The damping zone 27 forms a bridge between the locking plate 23 and the mounting plate 21 when viewed in the fastening plane of the mounting bracket. Preferably, there is no overlap between the locking plate 23 and the mounting plate 21 in this fastening plane that also is the plane of rotation of the tube. The damping zone 27 forms the only connection and provides stiffness in this plane of rotation and thus prevents unwanted torsion when operating the motor.

The damping zone 27 and the mounting plate 21 extend substantially in the same plane of rotation or fastening plane. In the shown preferred embodiment, the locking plate 23 has a perimeter edge 233, which lies substantially in the same plane as the damping zone 27 and the mounting plate 21. Optionally, the locking means 231 are slightly raised relative to the perimeter edge 233, as is shown. In general, the mounting plate, the damping zone and the locking plate substantially extend in the same plane.

In the shown first preferred embodiment, the mounting bracket 20 has a damping zone 27 with a closed structure. FIG. 3 shows a variant on this of the mounting bracket 20′ with a damping zone with a partly openwork structure formed by ribs 28 and openings 29.

Optionally, the mounting bracket 20, 20′ can be covered with an end cap 40 after mounting.

FIG. 4 shows a schematic view of a motorised roller blind 10 with a second preferred embodiment of a mounting bracket 120 according to the invention in disassembled parts. In the second preferred embodiment, the mounting bracket is arranged for mounting the motorised roller blind 10 in an elongated (extrusion) profile. In the relevant field various elongated profiles are known, such as a mounting profile or a cassette. In the second preferred embodiment, a cassette 50 provided with a frame 52 is shown, which is hung on a construction, in this example on a ceiling or a top side of a window frame, by means of cassette brackets 51.

With respect to the previous figures, similar reference numbers in different figures indicate similar parts and the reference numbers of modified parts have been increased by the number 100.

FIG. 5A shows the mounting bracket 120 and the bracket holder 30 from FIG. 4 in a first position, in which they are placed separate from each other. FIG. 5B shows the mounting bracket 120 and the bracket holder 30 from FIG. 5A in a second, assembled position.

FIG. 6 shows a front view of a variant of the second preferred embodiment of the mounting bracket according to the invention.

The mounting bracket 120 is provided with a mounting plate 121. The mounting plate 121 is manufactured from stiff material. In the second preferred embodiment, the shape of the mounting plate 121 is adapted to the cassette 50. The mounting bracket 120 is provided with two mounting supports 122 of stiff material for mounting in the cassette 50.

The mounting bracket 120 is further provided with a locking plate 23. The locking plate 23 is manufactured from stiff material and provided with locking means 231 that are arranged for locking in the bracket holder 30.

According to the invention, the mounting bracket 120 further comprises a damping zone 127 of vibration damping material, which damping zone 127 connects the locking plate 23 with the mounting plate 121.

The damping zone 127 is part of a collar 126 that extends partly over the mounting plate 121 and partly over the locking plate 23. The collar 126 has a general H-shaped cross-section with the damping zone 27 in the middle.

In the shown second preferred embodiment, the mounting bracket 120 has a damping zone 127 with a closed structure. FIG. 6 shows a variant of this of the mounting bracket 120′ with a damping zone with a partly openwork structure formed by ribs 128 and openings 129.

Optionally, the mounting bracket 120, 120′ can be covered with an end cap 140 after mounting. The mounting bracket 120, 120′ is there to optionally provided with ridges 141.

Suitable vibration damping material is more flexible or elastic than the stiff material of the mounting plate and the locking plate, but strong enough to carry a motorised screen. The property vibration damping refers to the material damping the (sound) vibrations of the motor, which would be directly transmitted to the construction in the absence of the vibration damping material. Instead of the term vibration damping, one could also use the terms sound damping, vibration absorbing or sound absorbing.

Suitable vibration damping materials are for example plastic, cork and rubber. The rubber can either be natural rubber or synthetic rubber, such as silicone or (poly)urethane. Preferably, the damping zone is manufactured of liquid silicone rubber (LSR). Preferably the material of the mounting plate and of the locking means is steel plate.

The mounting bracket according to the first and the second preferred embodiment according to the invention can be manufactured using the method according to the invention, which comprises the following steps.

In a first step, the mounting plate 21, 121 and the locking plate 23 are positioned inside a mould at a predetermined mutual distance, preferably in substantially the same plane.

Subsequently, in the space between the mounting plate 21, 121 and the locking plate 23 liquid vibration damping material is cast to connect the mounting plate 21, 121 and the locking plate 23 to each other.

Finally, the liquid vibration damping material is given time to harden into a connecting layer.

In the resulting fastening plane of the mounting bracket, the liquid vibration damping material forms the contact between the mounting plate and the locking plate. The vibration damping material lies like a collar around the locking plate with the locking means.

Alternatively, the mounting bracket according to the invention can be assembled from the separate parts, namely a mounting plate, a collar and locking means.

The mounting bracket according to the invention is provided with locking means, which are manufactured from stiff material and are part of a locking plate 23. The locking means are arranged for locking in a bracket holder on the motorised screen. The cooperation between the locking means and the bracket holder can be realised in several ways, for example by hooking and/or twisting or by means of a click lock.

In the shown preferred embodiments, a click lock is shown that in itself is known from the European patent EP2933428 of the same applicant. The locking means comprise a locking tooth 231 and the bracket holder 30 is provided with a slot, which is arranged for accommodating the locking tooth 231. For illustration purposes, in FIGS. 2A and 5A it can be seen that an end plate 33 is attached at a distance to the surface 17 of the motor head 14 using two spacers 32, wherein the space between the two spacers 32 forms the slot.

The bracket holder 30 is provided with an operable hook, which is attached on a lip 31 on the end plate 33. However, in the perspective of these figures, the hook is not visible. The locking tooth 231 is provided with a hole 232. When placing the locking tooth 231 in the slot, the hook will fall into the hole 232 and the bracket holder 30 will be locked into the mounting bracket 20. By operating the lip 31, the bracket holder 30 can be unlocked from the mounting bracket 20.

The locking plate 23 can optionally be provided with guiding teeth 24 and 25, which engage the outsides of the spacers. The guiding teeth 24 and 25 guide the bracket holder 30 into the mounting bracket 20. The locking tooth 231 and the guiding teeth 24 and 25 together form a fork.

Advantageously, the stiff locking means, such as the locking tooth 231, are attached to the mounting bracket 20, 20′, 120, 120′ and the moveable fastening means, such as the lip 31, are attached to the bracket holder 20.

The invention is obviously not limited to the described and shown preferred embodiments. The damping zone can take on different shapes or positions. The damping zone can for example be attached like a connecting layer between a partially overlapping mounting plate and locking plate. The mounting plate can also take on another shape and could even be a minimal ledge on the mounting bracket(s). The corresponding shape of the damping zone could then be rectangular. In practice, it can in some cases be sufficient to apply only one damping mounting bracket to the side of the motor. On the non-motor side, a standard mounting bracket without damping can then be applied.

The invention therefore extends to any embodiment that falls within the scope of protection, as defined in the claims and seen in the light of the preceding description and accompanying drawings.

1. A mounting bracket for mounting a motorised screen, to a construction, wherein the motorised screen comprises a rotatable tube and a motor, which is arranged for rotating the tube, which mounting bracket comprises a mounting plate of stiff material and is provided with locking means, which are arranged for locking the motorised screen, wherein the mounting bracket further comprises a mounting support for mounting to the construction, which mounting support is connected to the mounting plate, wherein the mounting bracket comprises a locking plate of stiff material, wherein the locking means are accommodated, and wherein the mounting bracket comprises a damping zone of vibration damping material that forms a connecting layer which connects the locking plate to the mounting plate and runs along a part of the contour of the locking plate, wherein the mounting plate, the damping zone and the locking plate substantially extend in the same plane.

2. The mounting bracket according to claim 1, wherein the mounting plate, the damping zone and the locking plate are permanently connected.

3. The mounting bracket according to claim 1, wherein the mounting plate has a recess, wherein the locking plate is at least partly accommodated, and wherein the damping zone runs along the contour of the recess.

4. The mounting bracket according to claim 3, wherein the recess is larger than the locking plate, and the damping zone bridges the space between the locking plate and the recess.

5. The mounting bracket according to claim 1, wherein the damping zone is a part of a collar that extends partly over the mounting plate and partly over the locking plate.

6. The mounting bracket according to claim 1, wherein the damping zone has a closed structure.

7. The mounting bracket according to claim 1, wherein the damping zone at least partly has an openwork structure.

8. The mounting bracket according to claim 1, wherein the vibration damping material comprises rubber, preferably synthetic rubber, such as silicone rubber.

9. The mounting bracket according to claim 1, wherein the damping zone is manufactured from liquid silicone rubber (LSR).

10. The mounting bracket according to claim 1, wherein the damping zone is arranged for cooperation with an end cap.

11. The mounting bracket according to claim 1, wherein the locking means at least comprise one locking tooth that is arranged for click locking in fastening means on the motorised screen.

12. The mounting bracket according to claim 11, wherein the locking means comprise two guiding teeth, which are attached to either side of the locking tooth, wherein the guiding teeth are arranged for guiding the fastening means on the motorised screen.

13. The mounting bracket according to claim 1, wherein the locking means are formed by one or more openings or recesses on the locking plate, which are arranged for accommodation of fastening means on the motorised screen.

14. The mounting bracket according to claim 1, wherein the motorised screen is a window covering.

15. The mounting bracket according to claim 1, wherein the construction is a surface.

16. The mounting bracket according to claim 1, wherein the construction is an elongated profile.

17. A method for manufacturing a mounting bracket for mounting a motorised screen to a construction, which mounting bracket comprises a mounting support for mounting to the construction and a mounting plate of stiff material arranged for locking the motorised screen, whereby the method comprises the following steps:
a) Positioning the mounting plate in a mould;
b) Positioning a locking plate with locking means of stiff plate material in the mould at some distance from the mounting plate;
c) Applying liquid vibration damping material in the mould in the space between the mounting plate and the locking plate such that the liquid vibration damping material forms the contact between the mounting plate and the locking plate; and
d) Letting the liquid vibration damping material cure.

18. An assembly of a mounting bracket for mounting a motorised screen and a bracket holder, wherein the motorised screen comprises a rotatable tube and a motor, which is arranged for rotating the tube, which mounting bracket comprises a mounting plate of stiff material and is provided with locking means, which locking means are arranged for locking the motorised screen, wherein the mounting bracket further comprises a mounting support for mounting to the construction, which mounting support is connected to the mounting plate, wherein the mounting bracket comprises a locking plate of stiff material, wherein the locking means are accommodated, and wherein the mounting bracket comprises a damping zone of vibration damping material that forms a connecting layer which connects the locking plate to the mounting plate and runs along a part of the contour of the locking plate, wherein the mounting plate, the damping zone and the locking plate substantially extend in the same plane, wherein the bracket holder is provided with fastening means that are arranged for forming a click lock with the locking means of the mounting bracket.
